(19) United States
(12) Patent Application Publication
(10) Pub. No.: US 2025/0301070 A1
(43) Pub. Date: Sep. 25, 2025

(54) IMAGE FORMING SYSTEM, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Yuki ANDO, Kanagawa (JP); Naohiro TATEISHI, Kanagawa (JP); Tetsuhiro INOUE, Kanagawa (JP)

(73) Assignee: FUJIFILM Business Innovation Corp., Tokyo (JP)

(21) Appl. No.: 18/784,859

(22) Filed: Jul. 25, 2024

(30) Foreign Application Priority Data
Mar. 25, 2024 (JP) 2024-047567

(51) Int. Cl. H04N 1/00

(52) U.S. Cl. CPC H04N 1/00045; H04N 1/00015; H04N 1/00037; H04N 1/00039; H04N 1/0005; H04N 1/00082; H04N 2201/0006; H04N 2201/0094

(57) ABSTRACT

An image forming system includes: an image scanning portion that scans an image formed on a paper; and a processor that controls image forming based on a scanned image obtained through scanning of the image scanning portion, in which the processor is configured to: define, in an intermediate state in which a reference point of a mark for positional deviation detection is not included in an analysis region set with respect to the scanned image and a part of the mark is included in the analysis region, a temporary position in place of an actual position of the reference point based on the part of the mark; and correct an image forming position on the paper based on the temporary position.

### CROSS-REFERENCE TO RELATED APPLICATIONS

This application is based on and claims priority under 35 USC 119 from Japanese Patent Application No. 2024-047567 filed Mar. 25, 2024.

### BACKGROUND

### (i) Technical Field

The present invention relates to an image forming system, a non-transitory computer readable medium storing a program, and an image forming method.

### (ii) Related Art

An image forming system is a system that forms an image on a paper. In the image forming system, an image forming position on the paper is changed due to various errors in paper conveyance processes, the expansion and contraction of the paper, and the like. Therefore, an image forming system including a function of correcting an image forming position while executing a print job has been proposed. More specifically, by scanning a first image formed on a first paper, which is a previous paper, and analyzing a scanned image obtained by scanning the first image, a positional deviation amount of the first image with respect to the first paper is obtained. A position where a second image is formed on a second paper, which is a subsequent paper, is corrected based on the positional deviation amount. A feedback correction based on such a scanned image is repeatedly executed.

An image forming system that corrects an image forming position through test printing is also known. In such an image forming system, test printing for printing a chart, which includes a plurality of marks on a paper, is performed. A scanned image is generated by scanning the paper, which is discharged after the test printing, with a document scanning apparatus. A position where the image is formed on the paper is corrected based on the scanned image, specifically, based on the positions of the plurality of marks included in the scanned image.

JP2016-25446A discloses a chart used in test printing. The chart includes a plurality of marks. Each mark has a cross shape.

### SUMMARY

In a case of correcting an image forming position based on a scanned image in an image forming system, in a case where the entire scanned image is set as an analysis target in analysis of a plurality of marks included in the scanned image, the problem of increased analysis time, increased analysis load, and the like occurs. Therefore, in general, a local analysis region is set for each mark with respect to the scanned image. In this case, in a state in which a reference point (for example, an intersection of a cross-shaped mark) of the mark is included in the analysis region, since an actual position of the reference point can be specified through an analysis of the mark, a positional deviation amount can be calculated based on the actual position, that is, the actual position can be used for correcting the image forming position.

On the other hand, a state in which the reference point is not included in the analysis region may also occur due to a large positional deviation of an image with respect to a paper or the like. In this case, the actual position of the reference point cannot be directly specified. In general, as the size of the mark is smaller, the analysis region is smaller, so that the reference point of the mark is more likely to be separated from the analysis region. Even in a case where the reference point of the mark is separated from the analysis region, acquiring position information, which may be used for correcting the image forming position, may be desired as much as possible.

Aspects of non-limiting embodiments of the present disclosure relate to an image forming system, a non-transitory computer readable medium storing a program, and an image forming method that can acquire position information used for correcting an image forming position as long as an analysis region and a mark are in a certain positional relationship even in a case where a reference point of the positioning mark is separated from the analysis region set with respect to a scanned image.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including: an image scanning portion that scans an image formed on a paper; and a processor that controls image forming based on a scanned image obtained through scanning of the image scanning portion, in which the processor is configured to: define, in an intermediate state in which a reference point of a mark for positional deviation detection is not included in an analysis region set with respect to the scanned image and a part of the mark is included in the analysis region, a temporary position in place of an actual position of the reference point based on the part of the mark; and correct an image forming position on the paper based on the temporary position.

### BRIEF DESCRIPTION OF THE DRAWINGS

Exemplary embodiment(s) of the present invention will be described in detail based on the following figures, wherein:

FIG. 1 is a schematic diagram showing an image forming system according to an exemplary embodiment;

FIG. 2 is a diagram showing a plurality of functions provided in a processor;

FIG. 3 is a diagram showing a composition of a main image and a sub-image;

FIG. 4 is a diagram showing an example of a deviation of an image with respect to a paper;

FIG. 5 is a diagram showing a plurality of analysis regions;

FIG. 6 is a diagram showing an example of an appropriate state;

FIG. 7 is a diagram showing an example of an intermediate state;

FIG. 8 is a diagram showing an example of an inappropriate state;

FIG. 9 is a diagram showing a first example of a temporary position defining method;

FIG. 10 is a diagram showing a second example of the temporary position defining method;

FIG. 11 is a diagram showing a method of detecting an end point;

FIG. 12 is a diagram showing a size condition for a cross-shaped mark;

FIG. 13 is a diagram showing a comparative example;

FIG. 14 is a diagram showing a size condition for an L-shaped mark;

FIG. 15 is a diagram showing defining a temporary position based on the L-shaped mark;

FIG. 16 is a diagram showing a size condition for a rectangle-shaped mark;

FIG. 17 is a diagram showing defining a temporary position based on the rectangle-shaped mark;

FIG. 18 is a flowchart showing an operation example;

FIG. 19 is a diagram showing a processor according to a modification example; and

FIG. 20 is a diagram showing an estimation of a temporary position according to the modification example.

### DETAILED DESCRIPTION

Hereinafter, an exemplary embodiment of the present invention will be described in detail with reference to the accompanying drawings.

### (1) Outline of Exemplary Embodiment

An image forming system according to an exemplary embodiment includes an image scanning portion and a processor. The image scanning portion scans an image formed on a paper. The processor controls image forming based on a scanned image obtained through scanning of the image scanning portion. More specifically, the processor defines, in an intermediate state in which a reference point of a mark for positional deviation detection is not included in an analysis region set with respect to the scanned image and a part of the mark is included in the analysis region, a temporary position in place of an actual position of the reference point based on the part of the mark. The processor corrects an image forming position on the paper based on the temporary position.

According to the above configuration, even in a case where the reference point is not included in the analysis region, that is, even in a case where the actual position of the reference point cannot be specified, the temporary position can be defined in place of the actual position based on the part (which may also be referred to as an attention part) of the mark included in the analysis region. The image forming position on the paper is corrected based on the temporary position. On the premise of such a mechanism, a relatively small analysis region may be set. The reference point may also be referred to as a feature point. The temporary position may be referred to as a directing position or a tentative position.

The image scanning portion is, for example, an image sensor. In general, the mark is a figure for specifying a positional deviation amount. The analysis region is a local region set on the scanned image. In general, since a plurality of marks are formed on the paper, a plurality of analysis regions corresponding to the plurality of marks are set with respect to the scanned image. A partial image included in each analysis region is analyzed. Accordingly, the actual position of the reference point is defined, the temporary position is defined in place of the actual position, or absence of mark is defined. The image forming position may be corrected in real time while executing a print job, or the image forming position may be corrected before executing a print job.

Examples of a method of defining the temporary position include a first method of defining the temporary position on an outer frame of the analysis region and a second method of defining the temporary position outside the outer frame of the analysis region. According to the first method, a reliable temporary position may be defined. Therefore, execution of excessive correction can be avoided. In addition, according to the first method, a part of the positional deviation amount can be resolved through the previous correction, and the possibility that the reference point is included in the analysis region is increased in the subsequent correction. On the other hand, according to the second method, the temporary position may be made closer to the actual position. A modification example is also considered in which the temporary position is defined inside the outer frame of the analysis region.

In the exemplary embodiment, the temporary position is defined on the outer frame. In a case where the mark crosses a specific horizontal side of the outer frame, the processor defines a vertical coordinate of the temporary position based on a vertical coordinate of the specific horizontal side and defines a horizontal coordinate of the temporary position based on a horizontal coordinate of the part of the mark. On the other hand, in a case where the mark crosses a specific vertical side of the outer frame, the processor defines the horizontal coordinate of the temporary position based on a horizontal coordinate of the specific vertical side and defines the vertical coordinate of the temporary position based on a vertical coordinate of the part of the mark.

According to the above configuration, coordinates of a side where the mark crosses may be used in defining coordinates of the temporary position. The outer frame typically has a rectangle-shaped form, and in this case, the outer frame is configured with two horizontal sides (upper side and lower side) and two vertical sides (left side and right side).

In the exemplary embodiment, the processor identifies the specific horizontal side or the specific vertical side by specifying at least one of a contact portion between the outer frame and the part of the mark, an end portion of the part of the mark in the outer frame, or a gap between the outer frame and the part of the mark. In the intermediate state, the size of the analysis region and the size of the mark are defined such that the end portion and the gap are generated, in other words, such that the two contact portions are not generated at the same time. The contact portion is, for example, a contact point or a contact region. The end portion is, for example, an end point or an end region.

In the exemplary embodiment, the processor generates a vertically integrated image and a horizontally integrated image by integrating partial images in the analysis region in a vertical direction and a horizontal direction. The processor specifies at least one of the contact portion, the end portion, or the gap by analyzing the vertically integrated image and the horizontally integrated image. By defining the vertically integrated image and the horizontally integrated image as analysis targets, the part of the mark, that is, the attention part of the mark can be easily and accurately analyzed.

In the exemplary embodiment, the horizontal coordinate or the vertical coordinate of the part of the mark is a horizontal coordinate or a vertical coordinate of a representative point that represents the part of the mark. The representative point is, for example, a contact point, an end point, an intermediate point, or a center point. In the exemplary embodiment, the part of the mark is a line segment. The representative point is a contact point between the part of the mark and the outer frame. In general, in the analysis region, the part of the mark has a width. One of the positions in the contact portion that is generated through the intersection between the part and the outer frame is defined as a contact point.

In the exemplary embodiment, the mark includes a first vertical line that extends in the vertical direction from the reference point and a first horizontal line that extends in the horizontal direction from the reference point. The outer frame of the analysis region has a first vertical size in the vertical direction and has a first horizontal size in the horizontal direction. The first vertical line has a second vertical size smaller than the first vertical size in the vertical direction. The first horizontal line has a second horizontal size smaller than the first horizontal size in the horizontal direction.

In the above configuration, the mark has, for example, a cross shape and an L-shape. In a case where the size of the analysis region and the mark is defined such that the above-described size condition is satisfied, since the end portion of the part and the gap appear in the intermediate state, a movement direction of the mark with respect to the analysis region may be easily specified. That is, in the intermediate state, a state does not occur in which the part of the mark crosses two vertical sides or two horizontal sides at the same time.

In the exemplary embodiment, the mark further includes a second vertical line that extends in the vertical direction from the reference point and that is connected to the first vertical line via the reference point and a second horizontal line that extends in the horizontal direction from the reference point and that is connected to the first horizontal line via the reference point. The second vertical line has the second vertical size in the vertical direction. The second horizontal line has the second horizontal size in the horizontal direction.

In the above configuration, for example, the mark has a cross shape. According to the above configuration, even in a case where the mark is moved in a direction either a positive side or a negative side of the vertical direction, or even in a case where the mark is moved in a direction either a positive side or a negative side of the horizontal direction, the movement direction of the mark may be specified.

In the exemplary embodiment, the outer frame of the analysis region has the first vertical size in the vertical direction and has the first horizontal size in the horizontal direction. The mark has a size twice a second vertical size in the vertical direction and has a size twice a second horizontal size in the horizontal direction. The second vertical size is smaller than the first vertical size, and the second horizontal size is also smaller than the first horizontal size.

In the above configuration, the mark has, for example, a rectangle shape or a cross shape. In a case where a rectangle-shaped mark (including a filled rectangle-shaped mark) is used, the center of gravity of the mark may be defined as the reference point.

In the exemplary embodiment, the processor estimates, in the intermediate state, a position of the reference point based on the part of the mark and defines the estimated position as the temporary position. For example, the actual position of the reference point may be estimated from a part of the analysis region by using an extrapolation method. The temporary position may be defined on an extension line of the part outside the outer frame.

In the exemplary embodiment, the processor defines, in an appropriate state in which the reference point of the mark is included in the analysis region, the actual position of the reference point and corrects the image forming position based on the actual position. The processor determines an error in an inappropriate state in which the mark is not included in the analysis region.

In the exemplary embodiment, the processor defines the actual position or the temporary position based on a first scanned image obtained by scanning a first image formed on a first paper. The processor corrects in real time a position where a second image is formed on a second paper based on the actual position or the temporary position. The above configuration corrects the image forming position in real time while executing a print job on the premise of feedback control.

A program, which is executed by the above processor, may be installed in the image forming system via a network or via a portable storage medium. The image forming system may be configured with one apparatus or a plurality of apparatuses from a physical perspective. The apparatuses may be connected to each other via a network. The image forming system is an information processing apparatus. The image forming system includes a non-transitory storage medium storing the above program.

### (2) Detail of Exemplary Embodiment

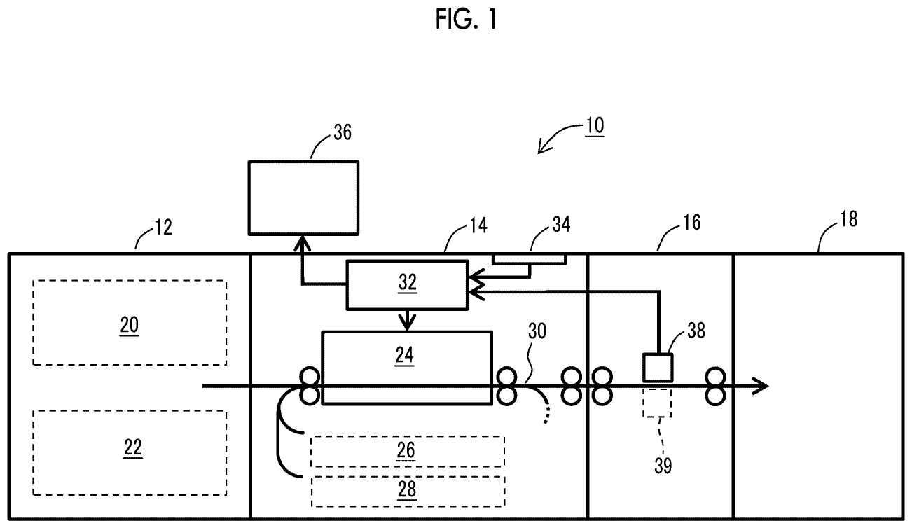

FIG. 1 shows a configuration example of the image forming system according to the exemplary embodiment. An image forming system 10 shown in the drawing sequentially forms a plurality of images on a plurality of papers and has a function of correcting the image forming position in real time through feedback control while executing a print job. The correction of the image forming position is also called registration correction or registration adjustment.

In FIG. 1, the image forming system 10 consists of a paper feeding apparatus 12, an image forming apparatus 14, an examination apparatus 16, and a post-processing apparatus 18. In the correction of the image forming position, at least the image forming apparatus 14 and the examination apparatus 16 function to correct the image forming position. The examination apparatus 16 may be incorporated in the image forming apparatus 14.

The paper feeding apparatus 12 includes two paper feeding trays 20 and 22. Each of paper feeding trays 20 and 22 is a large paper feeding tray and may accommodate, for example, several thousand papers. The plurality of papers are sequentially supplied from the paper feeding apparatus 12 to the image forming apparatus 14. Each individual paper is a medium on which an image is formed.

The image forming apparatus 14 includes an image forming portion 24. In the exemplary embodiment, the image forming portion 24 is an image forming engine that forms each image on each paper in accordance with an electrophotographic method. More specifically, the image forming portion 24 includes a rotating intermediate transfer belt, and a plurality of photosensitive body units. The plurality of photosensitive body units are arranged in a movement direction of the intermediate transfer belt. A plurality of color toner images are sequentially transferred to the intermediate transfer belt by the plurality of photosensitive body units. As a result, the multiple toner images, which are generated by the above-described process, are transferred from the intermediate transfer belt to the paper. The image may be formed on the paper by using a method other than the electrophotographic method (for example, an ink jet method).

The image forming apparatus 14 includes paper feeding trays 26 and 28. As necessary, the plurality of papers are sequentially supplied from the paper feeding trays 26 and 28 to the image forming portion 24. The capacities of the respective paper feeding trays 26 and 28 are smaller than the capacities of the respective paper feeding trays 20 and 22. The reference numeral 30 denotes a paper conveyance path. The paper conveyance path 30 is provided over the paper feeding apparatus 12, the image forming apparatus 14, the examination apparatus 16, and the post-processing apparatus 18. In FIG. 1, the left side of the paper conveyance path 30 is the upstream side, and the right side thereof is the downstream side.

The image forming apparatus 14 includes a control portion 32. The control portion 32 controls an operation of each element in the image forming system 10. Image data is sequentially transferred from the control portion 32 to the image forming portion 24. The control portion 32 controls an operation of the image forming portion 24. That is, the control portion 32 controls the formation of each image on each paper. The control of the control portion 32 includes a deviation correction control in real time. The control portion 32 corrects positional deviations of the image with respect to the paper.

The control portion 32 includes a processor that executes a program. The processor is, for example, a CPU. An operation panel 34 and a displayer 36 are connected to the control portion 32. The operation panel 34 is, for example, a screen panel with a touch sensor. Another input device may be connected to the control portion 32. The displayer 36 is, for example, a liquid crystal displayer. The entire or a part of the control portion 32 may be provided outside the image forming apparatus 14.

In general, the control portion 32 is connected to the information processing apparatus via a network and executes a print job sent from the information processing apparatus. The print job includes a plurality of images and printing instructions for the plurality of images. Hereinafter, in some cases, each input image is referred to as a main image.

The control portion 32 generates a composite image for each main image by composing a sub-image with the main image. The composite image is formed on each paper. The sub-image includes a plurality of marks for post-specifying the positional deviation amounts. Such a mark is also called a register mark. The image forming apparatus 14 includes a return paper conveyance path that is used in a case of forming an image on a back side of the paper, but the return paper conveyance path is not shown.

The examination apparatus 16 scans the image to examine the image formed on each paper. Specifically, the examination apparatus 16 includes an image sensor 38. The image sensor 38 corresponds to the image scanning portion. The image sensor 38 is an in-line sensor provided on the paper conveyance path 30. The image sensor 38 includes, for example, a plurality of detection elements arranged in a direction (hereinafter, also referred to as a second direction in some cases) orthogonal to the paper conveying direction (hereinafter, also referred to as a first direction in some cases). A scanner that scans the image through laser scanning in a second direction may be used as the image sensor 38. An image scanning device other than the above may be used as the image sensor 38.

The image sensor 38 is provided on the downstream side of the image forming portion 24 on the paper conveyance path 30. In the configuration example shown in the drawing, a scanned image (accurately, scanned image data) obtained through scanning of the image sensor 38 is transmitted to the control portion 32.

The examination apparatus 16 includes an image sensor 39 in addition to the image sensor 38. The image formed on a front side of the paper is scanned by the image sensor 38. The image formed on a back side of the paper is scanned by the image sensor 39. The correction of the image forming position applied to a front side of the paper and the correction of the image forming position applied to a back side of the paper are basically the same, and the correction of the image forming position applied to the front side of the image will be described below. The post-processing apparatus 18 includes a plurality of post-processing functions such as a trimming function, a folding function, and a punching function. In the post-processing apparatus 18, normally, a peripheral region of the paper is cut off for each paper. The peripheral region is a margin region where the plurality of marks or the like are formed. The above described sub-image is, for example, an image for forming the plurality of marks or the like with respect to a peripheral region of the paper. An apparatus including a discharge tray or a discharge stacker is usually provided in a subsequent stage of the post-processing apparatus 18.

The operation of the image forming system 10 will be summarized. A plurality of image-formed papers are sequentially discharged from the image forming portion 24 to a downstream side of the image forming portion 24. The image formed on each paper includes a plurality of marks for specifying the positional deviation amount. The image sensor 38 sequentially scans the plurality of images formed on the plurality of papers. A plurality of scanned images generated through scanning are sequentially transmitted from the image sensor 38 to the control portion 32. The control portion 32 calculates the positional deviation amounts for each scanned image by analyzing the scanned image. In this case, a plurality of analysis regions corresponding to the plurality of marks are defined for each scanned image. The control portion 32 analyzes a partial image included in each analysis region. The control portion 32 calculates the positional deviation amount based on a plurality of analysis results corresponding to the plurality of analysis regions. The control portion 32 corrects the image forming position with respect to the paper such that the positional deviation amount is resolved, based on the positional deviation amount.

In a case where the paper, which is a scanning target, is referred to as a first paper and the image, which is formed on the first paper, is referred to as a first image, the positional deviation amount is specified by analyzing the first scanned image obtained by scanning the first image, and the forming position of the second image on the second paper is corrected based on the positional deviation amount. Here, the first paper is a previous paper, and the second paper is a subsequent paper. Normally, a plurality of printed papers to be scanned are present between the first paper and the second paper.

Examples of the positional deviation include a positional deviation due to an image shift in the vertical direction, a positional deviation due to an image shift in the horizontal direction, a positional deviation due to image rotation, a positional deviation due to a scale deviation, and the like. In reality, the control portion 32 has a function of collectively correcting the positional deviations.

In order to correct the positional deviations, specifying the positional deviation or the positional deviation amount of the mark is necessary for each mark. In the exemplary embodiment, the partial image in the analysis region is analyzed as follows in order to specify the positional deviation of the mark.

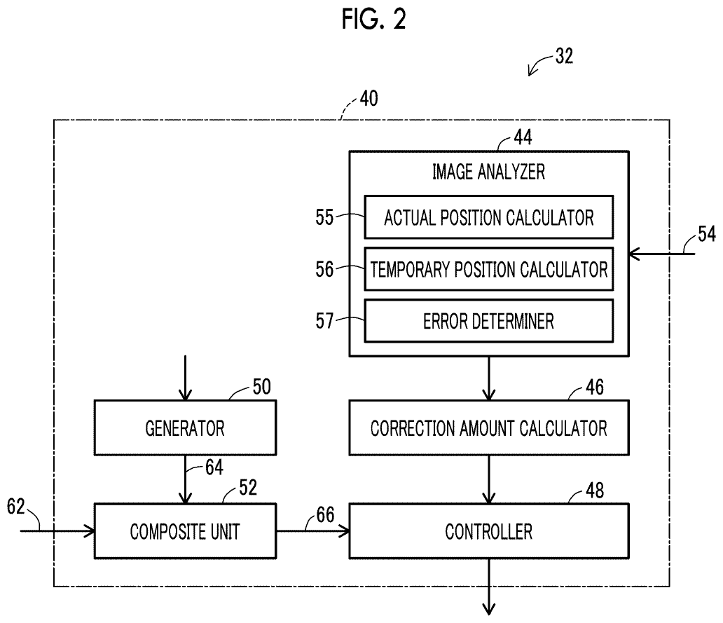

FIG. 2 shows a configuration example of the control portion 32. The control portion 32 includes a processor 40. A memory (not shown) is connected to the processor. In FIG. 2, a plurality of functions exerted by the processor 40 are represented with a plurality of blocks. The processor 40 functions as an image analyzer 44, a correction amount calculator 46, a controller 48, a generator 50, and a composite unit 52. In FIG. 2, the configuration that is not directly related to the correction of the image forming position is not shown.

The image analyzer 44 includes an actual position calculator 55, a temporary position calculator 56, and an error determiner 57 that selectively function depending on the state. The actual position calculator 55 calculates the position of the reference point as the actual position in the appropriate state in which the reference point (for example, an intersection of a cross-shaped mark) of the mark is included in the analysis region. The temporary position calculator 56 calculates, in the intermediate state in which the reference point of the mark is not included in the analysis region and the part of the mark is included in the analysis region, the temporary position in place of the actual position based on the part of the mark. In the intermediate state, the part of the mark may be referred to as an attention part. In the exemplary embodiment, the temporary position is defined on the outer frame of the analysis region. Description will be made in detail later related to the above. The error determiner 57 determines an error in the inappropriate state in which the mark is not included in the analysis region. That is, in a case where neither the actual position nor the temporary position can be calculated, an error is determined.

The correction amount calculator 46 calculates the positional deviation amount of the image with respect to the paper based on the plurality of analysis results corresponding to the plurality of analysis regions for each scanned image 54. Specifically, the correction amount calculator 46 calculates the positional deviation amount of the image by individually comparing a plurality of actual positions or a plurality of temporary positions, which are calculated by analyzing the plurality of marks, with a plurality of preset positions. The correction amount calculator 46 calculates a current correction amount based on the positional deviation amount.

The controller 48 controls the operation of the image forming portion, and specifically corrects the image forming position based on the correction amount such that the positional deviation of the image with respect to the paper is resolved or reduced. The correction of the image forming position may include correction by mechanical control, in addition to correction by electronic control.

The generator 50 generates a sub-image 64 including a plurality of marks. The generator 50 may be configured in the memory. The composite unit 52 composes the sub-image 64 with each input image, that is, each main image 62 and generates a composite image 66. The composite image 66 is transmitted to the image forming portion through the controller 48 in the shown configuration example.

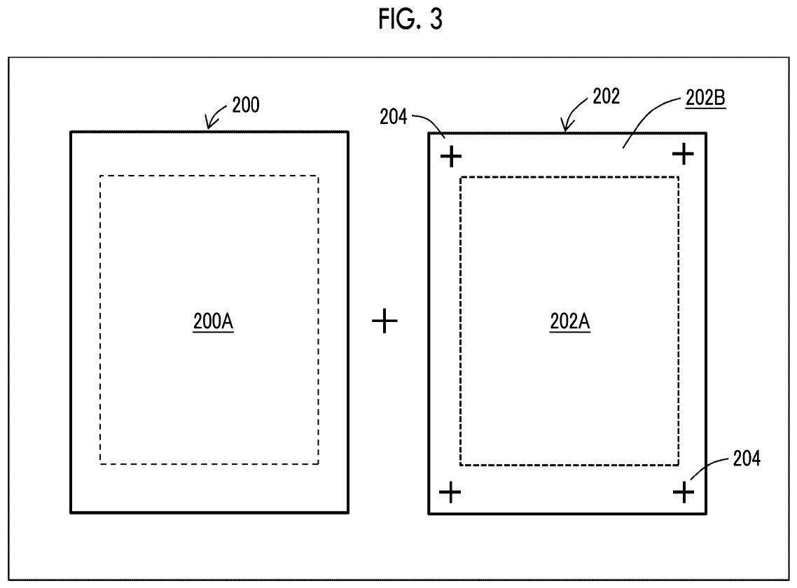

FIG. 3 shows the composition of the main image 200 and the sub-image 202. The main image 200 is an input image. The main image 200 includes a content region 200A where a character, a figure, and a photograph are included. The sub-image 202 includes a first region 202A corresponding to a content region 200A and a second region 202B corresponding to a peripheral region. The second region 202B includes a plurality of marks 204. The composite image is formed on the paper. The forming of the image may be referred to as printing the image.

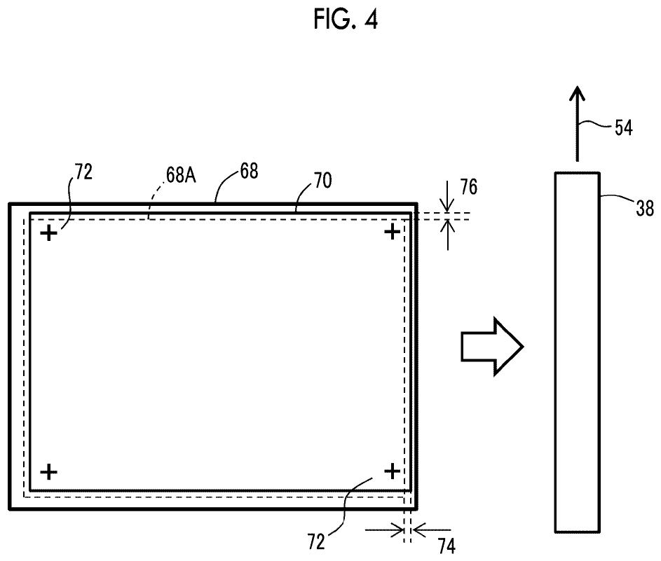

FIG. 4 schematically shows an example of a positional deviation. An image 70 is formed on a paper 68. The reference numeral 68A denotes a correct image forming region. A plurality of marks 72 are included in a peripheral region in the image 70. In FIG. 4, a right-left direction is the paper conveying direction, that is, the first direction. A direction orthogonal to the first direction is the second direction.

The image 70 is deviated with respect to the paper 68. Specifically, the reference numeral 74 denotes the positional deviation amount in the first direction, and the reference numeral 76 denotes the positional deviation amount in the second direction. The image 70 is scanned by the image sensor 38 during the conveyance of the paper 68, and the scanned image 54 is generated through the scanning. The scanned image 54 is transmitted to the control portion. In the control portion, a position of each mark in the scanned image 54 is analyzed, and then the positional deviation amount 74 in the first direction and the positional deviation amount 76 in the second direction are calculated.

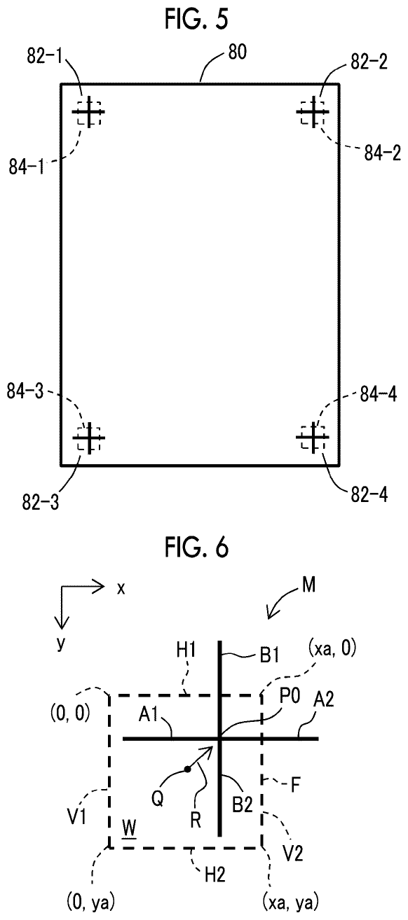

FIG. 5 shows the scanned image 80. The scanned image 80 includes a plurality of marks 82-1 to 82-4. Accurately, each of the marks 82-1 to 82-4 is a mark image. Here, the marks 82-1 to 82-4 each have a cross shape. In the analysis of the scanned image, a plurality of analysis regions 84-1 to 84-4 are set with respect to the scanned image 80. The analysis regions 84-1 to 84-4 are local regions or small regions, and a partial image in each of the analysis regions 84-1 to 84-4 is an analysis target. In a case where the entire scanned image 80 is set as the analysis target, a processing amount is increased. However, according to the setting of the plurality of analysis regions 84-1 to 84-4, the processing amount can be reduced.

As described above, the image forming system according to the exemplary embodiment includes the temporary position calculator that functions in the intermediate state. In the intermediate state, the temporary position is calculated in place of the actual position, and the temporary position is used with correction of the image forming position.

FIG. 6 shows the appropriate state. The x direction is the horizontal direction, and the y direction is the vertical direction. The analysis region W is a rectangle-shaped (square in the example shown in the drawing) region. The analysis region W includes an outer frame F. The outer frame F consists of a horizontal side (upper side) H1, a horizontal side (lower side) H2, a vertical side (left side) V1, and a vertical side (right side) V2. The analysis region W includes a center Q. Coordinates of an upper left corner of the outer frame F are (0, 0), coordinates of an upper right corner of the outer frame F are (xa, 0), coordinates of a lower left corner of the outer frame F are (0, ya), and coordinates of a lower right corner of the outer frame F are (xa, ya).

The mark M includes a reference point P0 as an intersection. The positional deviation of the reference point P0 is represented by a vector R. The mark M includes a horizontal line A1 that extends in the −x direction, a horizontal line A2 that extends in the +x direction, a vertical line B1 that extends in the −y direction, and a vertical line B2 that extends in the +y direction, from the reference point P0. The horizontal line A1 and the horizontal line A2 are connected through the reference point P0. Similarly, the vertical line B1 and the vertical line B2 are connected through the reference point P0.

As shown in FIG. 6, in the appropriate state, since the reference point P0 is included in the analysis region W, the position of the reference point P0 (that is, the actual position) can be easily specified based on the partial image in the analysis region W. In this case, an x direction projection image and a y direction projection image may be generated based on the partial image, and the actual position of the reference point P0 may be calculated by analyzing the x direction projection image and the y direction projection image. In calculating the actual position, a pattern matching method, a line extraction method, or the like may be used.

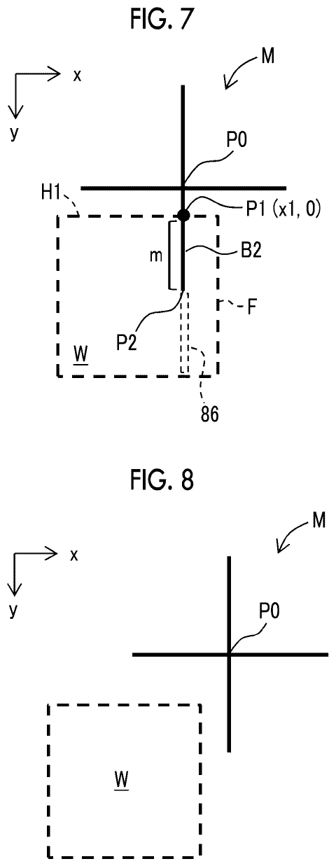

FIG. 7 shows the intermediate state. The reference point P0 of the mark M is present outside the analysis region W, that is, outside the outer frame F. In the intermediate state, the reference point P0 is not included in the partial image as the analysis target, and directly specifying the actual position of the reference point P0 is difficult.

In the mark M, a part “m” of the vertical line B2 is present in the analysis region W. Therefore, in the exemplary embodiment, a position of a contact point P1 is calculated as the temporary position in place of the actual position of the reference point P0 based on the part “m”. The part “m” is a line segment having an end point P2, and the part “m” is in contact with the outer frame F at the contact point P1.

In the example shown in the drawing, the contact point P1 is on the horizontal side H1, and the coordinates of the temporary position are (x1, 0). Specifically, the x coordinate (x1) of the temporary position is specified by analyzing the part “m”. The y coordinate of the temporary position is specified by the y coordinate of the horizontal side H1. That is, in defining the coordinates of the temporary position, the coordinate of the horizontal side or the vertical side in contact with the part “m” is used.

In a case where the mark M is shifted with respect to the analysis region W, the end point P2 appears, and at the same time, a gap 86 appears between the end point P2 and the outer frame F. In specifying the horizontal side or the vertical side with which the part “m” is in contact, the end point P2 or the gap 86 may be used in place of the contact point. A plurality of feature quantities appearing in the intermediate state may be referred to at the same time.

FIG. 8 shows the inappropriate state. The mark M is completely separated from the analysis region W. That is, the reference point P0 of the mark M is outside the analysis region W, and none of the lines in the mark M are not within the analysis region W. In such an inappropriate state, since neither the calculation of the actual position nor the calculation of the temporary position can be performed, an error is determined.

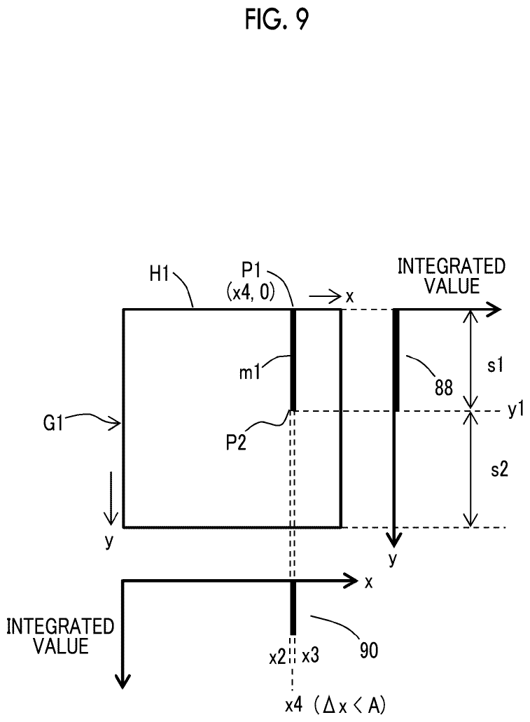

FIG. 9 shows a first example of the temporary position defining method. By projecting a partial image G1 in the analysis region in the x direction, an x direction projection image (also referred to as a horizontal direction projection image) 88 is generated. Similarly, by projecting the partial image G1 in the y direction, a y direction projection image (also referred to as a vertical direction projection image) 90 is generated. In reality, a black and white inversion process is applied to the partial image G1, and each of projection images 88 and 90 is generated from the partial image G1 after the black and white inversion. In the black and white inversion process, the minimum pixel value is converted into the maximum pixel value, and the maximum pixel value is converted into the minimum pixel value.

The x direction projection image 88 includes a y axis and an axis indicating an integrated value. Here, the integrated value is a value calculated through an integration process after the black and white inversion process. In the example shown in the drawing, the y coordinate (y1) of the end point is specified by edge detection, a threshold value process, and the like with respect to the x direction projection image 88. A part m1 is present in an upper section s1 with respect to the coordinate y1. The part m1 is not included in a lower section s2 with respect to the coordinate y1. Therefore, a side with which the part m1 is in contact may be specified based on the x direction projection image 88. A side with which the part m1 is in contact may be specified based on a gap adjacent to the end point P2.

The y direction projection image includes an x axis and an axis indicating an integrated value. In the example shown in the drawing, a large integrated value is generated in a range from x2 to x3. For example, in a case where an absolute value of a difference Δx between x2 and x3 is smaller than a threshold value A, an intermediate position x4 between x2 and x3 is defined to be the x coordinate of the temporary position. The threshold value A is a numerical value for evaluating the degree of inclination.

Even in a case where the part ml of the mark is parallel to the x direction instead of the y direction, the temporary position may be specified by using the same method as described above.

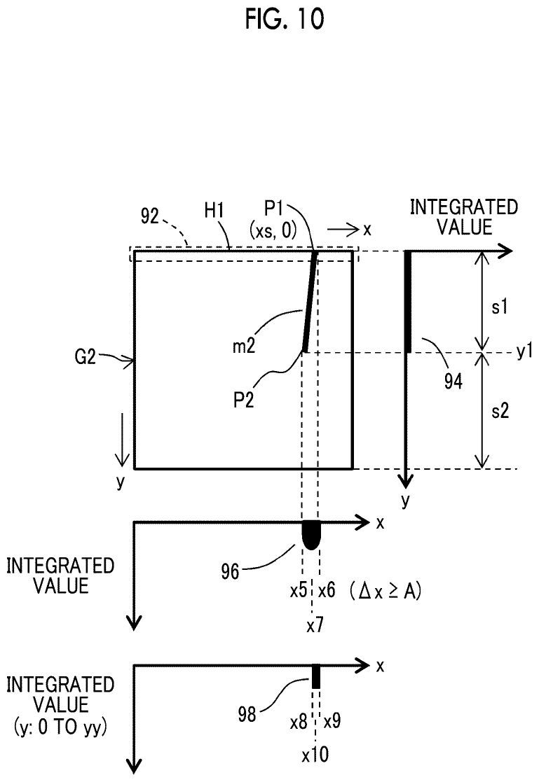

FIG. 10 shows a second example of the temporary position defining method. A partial image G2 includes a part m2 that is slightly inclined with respect to the y direction. By projecting the partial image G2 in the analysis region in the x direction, an x direction projection image 94 is generated. Similarly, by projecting the partial image G2 in the y direction, a y direction projection image 96 is generated. In reality, first, the black and white inversion process is applied to the partial image G2, and each of projection images 94 and 96 is generated from the partial image G1 after the black and white inversion.

Similar to the above, the y coordinate (y1) of the end point P2 may be specified by the edge detection, the threshold value process, and the like with respect to the x direction projection image 94. The section s1 including the part m2 and the section s2 not including the part m2 are defined with the y coordinate of the end point P2 as a boundary.

The y direction projection image 96 is slightly spread in the x direction. The x coordinates of both ends thereof are x5 and x6. An absolute value of a difference Ax is equal to or larger than a threshold value A. Although an intermediate position x7 between x5 and x6 can be defined as an x coordinate (xs) of the temporary position, in the example shown in the drawing, the following processing is applied.

By projecting only a strip-shaped region (for example, a region where the y coordinate is from 0 to yy) 92 in the vicinity of the horizontal side H1 of the partial image G2 in the y direction, a y direction projection image 98 is generated. An intermediate position x10 between x8 and x9, which are x coordinates of both ends thereof is defined as the x coordinate of the contact point P1, that is, the x coordinate (xs) of the temporary position. The intermediate position x10 is simply an x coordinate of a contact point. Even in a case where the part m2 of the mark extends while being inclined along the x direction, the coordinates of the temporary position can be calculated by using the same method as described above.

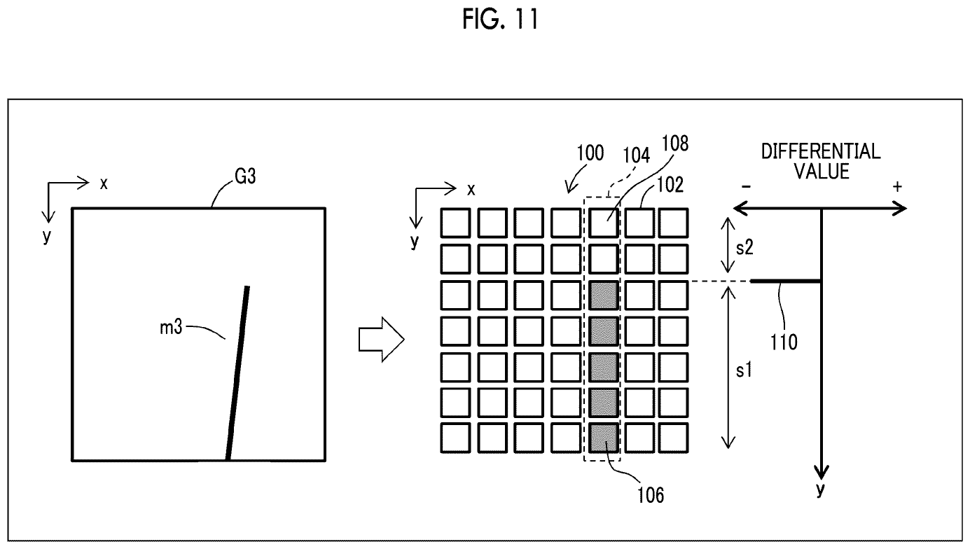

FIG. 11 shows another example of a method of detecting an end point. The partial image G3 includes a part m3 of the mark. Here, a color of the ground of the partial image G3 is a color of white, and a color of the mark is black. A two-dimensional matrix 100 is configured with a plurality of cells 102 arranged in the x direction and the y direction. The two-dimensional matrix 100 is used for down-sampling the partial image G3. In the partial image G3, a minimum value pooling process is applied in which a minimum value is extracted from a region (pixel value group) corresponding to each cell and the minimum value is stored in the cell.

With the above processing, in the example shown in the drawing, the part m3 of the mark is aggregated in a specific cell column 104. In the example shown in the drawing, the cell column 104 consists of a plurality of cells 106 including the part m3 and a plurality of cells 108 not including the part m3. In a case where a differential process is performed from one end to the other end with respect to the cell column 104, a differential waveform 110 is obtained. Here, in a case where the differential waveform 110 is generated on the negative side, this means a transition from a gap (white) to a mark (black). In other words, this means that an upper end of the part m3 is present. In a case where the differential waveform 110 is generated on the positive side, this means a transition from the mark to the gap.

In the example shown in the drawing, the reference numeral s1 denotes a section including the part m3, and the reference numeral s2 denotes a section not including the part m3. Even in a case where the part m3 is along the x direction, the end point can be identified by using the same method as described above.

In a case where the end point is identified, a specific side, which is in contact with the part, can be identified from the end point. A side, which is in contact with the part, may be specified in a direction where the part extends from the end point or from a position of the gap. Of course, a specific side may be identified by specifying a contact point in the part.

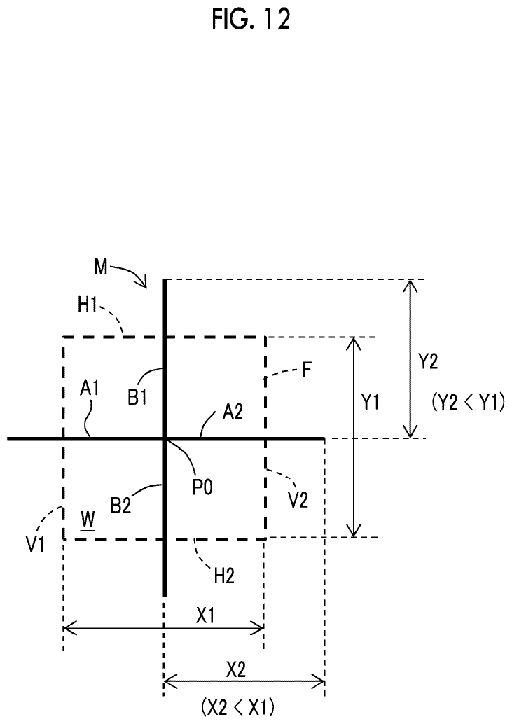

Next, a plurality of size conditions for the plurality of marks will be described with reference to FIGS. 12 to 17.

FIG. 12 shows a cross-shaped mark M. The mark M includes a reference point P0 and includes a horizontal line A1, a horizontal line A2, a vertical line B1, and a vertical line B2 extending from the reference point. An analysis region W includes an outer frame F, and the outer frame F includes a horizontal side H1, a horizontal side H2, a vertical side V1, and a vertical side V2. The size of the analysis region W in the horizontal direction is X1, and the size of the analysis region W in the vertical direction is Y1. The sizes of the two horizontal lines A1 and A2 are the same, and are specifically X2. The sizes of the two vertical lines B1 and B2 are the same, and are specifically Y2.

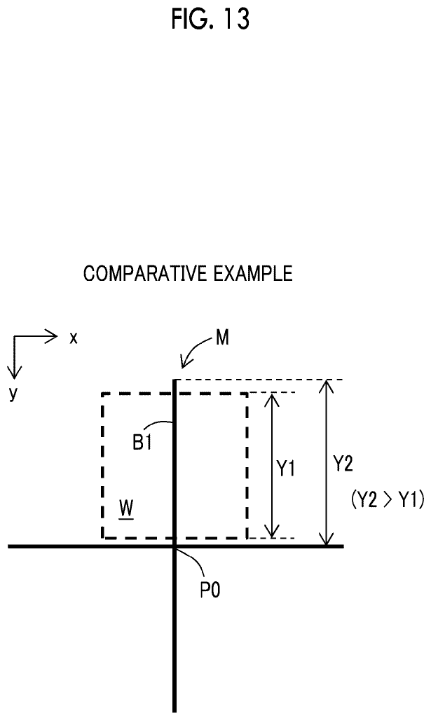

In the exemplary embodiment, in the intermediate state, the size conditions of X2<X1 and Y2<Y1 are satisfied such that an end of the part of the mark appears, in other words, such that the part does not cross two sides at the same time. In a case where the size condition is not satisfied, a situation as shown in FIG. 13 occurs. In FIG. 13, the reference point P0 in the mark M is separated from the analysis region W, and the part (vertical line B1) of the mark M is included in the analysis region W. Therefore, the intermediate state occurs. However, the vertical line B1 passes through both of the two horizontal sides, and thus the shift direction of the mark M cannot be specified from only the partial image in the analysis region W. The size condition is defined such that the end of the part of the mark appears before the reference point P0 is separated from the analysis region W or from a time point when the reference point P0 is separated from the analysis region W. The size condition is also effective for other marks as described below.

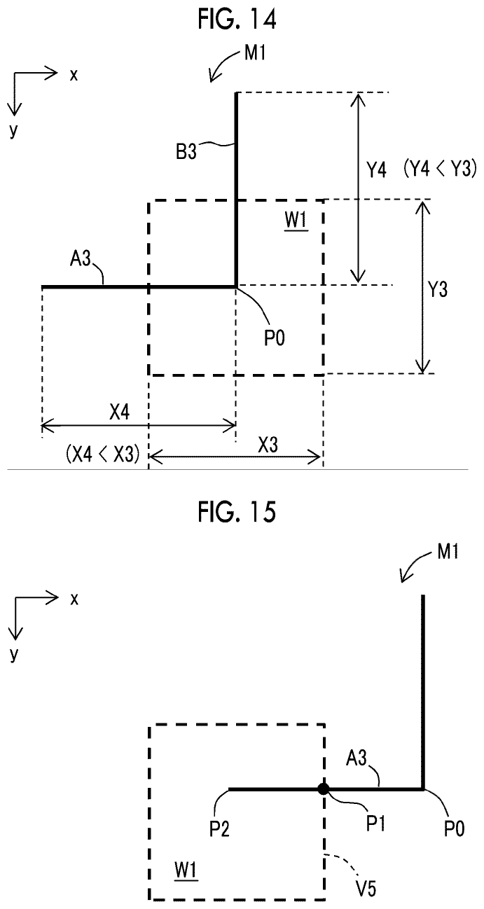

FIG. 14 shows an L-shaped mark M1. The mark M1 includes a reference point P0 and includes a horizontal line A3 and a vertical line B3 extending from the reference point P0. The size of the analysis region W1 in the x direction is X3, and the size of the analysis region W1 in the y direction is Y3. In the mark M1, the size of the horizontal line A3 is X4, and the size of the vertical line B3 is Y4. Here, the size conditions of X4<X3 and Y4<Y3 are satisfied. In a case where the size condition is satisfied, and in a case where the mark M1 is shifted in the x direction and the reference point P0 is separated from the analysis region W1 as shown in FIG. 15, the end point P2 of the horizontal line A3 reliably appears in the analysis region W1. In the example shown in the drawing, a vertical side V5 and a horizontal line A3 intersect with each other, and the contact point P1 is defined on the vertical side V5. The position of the contact point P1 is defined as the temporary position in place of the actual position.

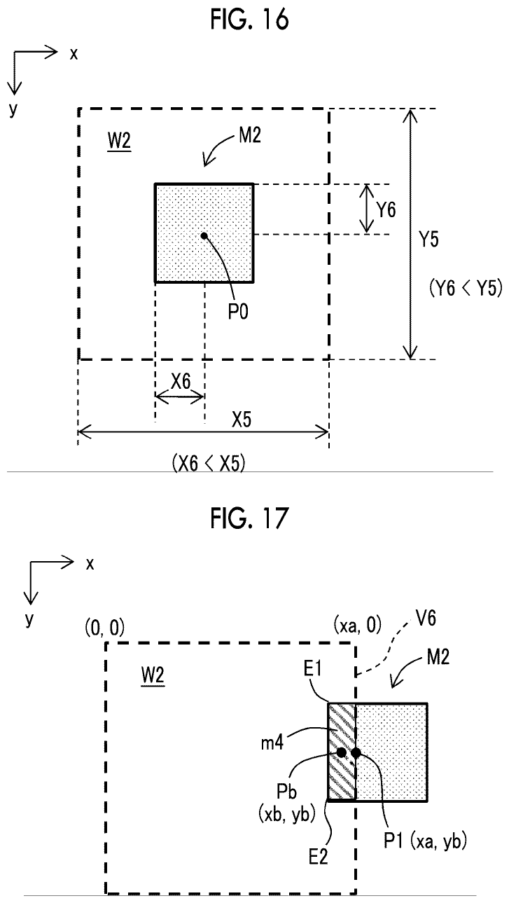

FIG. 16 shows a rectangle-shaped mark M2. The mark M1 is filled with, for example, a color of black. Here, the center of gravity of the mark M2 is the reference point P0 of the mark M2. The size of the analysis region W in the horizontal direction is X5, and the size of the analysis region W in the vertical direction is Y5. The mark M2 has a size of X6×2 in the x direction and has a size of Y6×2 in the y direction. Here, the size conditions of X6<X5 and Y6<Y5 are satisfied. As shown in FIG. 17, in the intermediate state, a part m4 of the mark M2 belongs to the analysis region W2. The center of gravity Pb of the part m4 is calculated. The coordinates of the center of gravity Pb are (xb, yb). The x coordinate of a vertical line V6, which is in contact with the part m4, is xa. From the above, the coordinates (xa, yb) of the contact point P1 are specified as the coordinates of the temporary position.

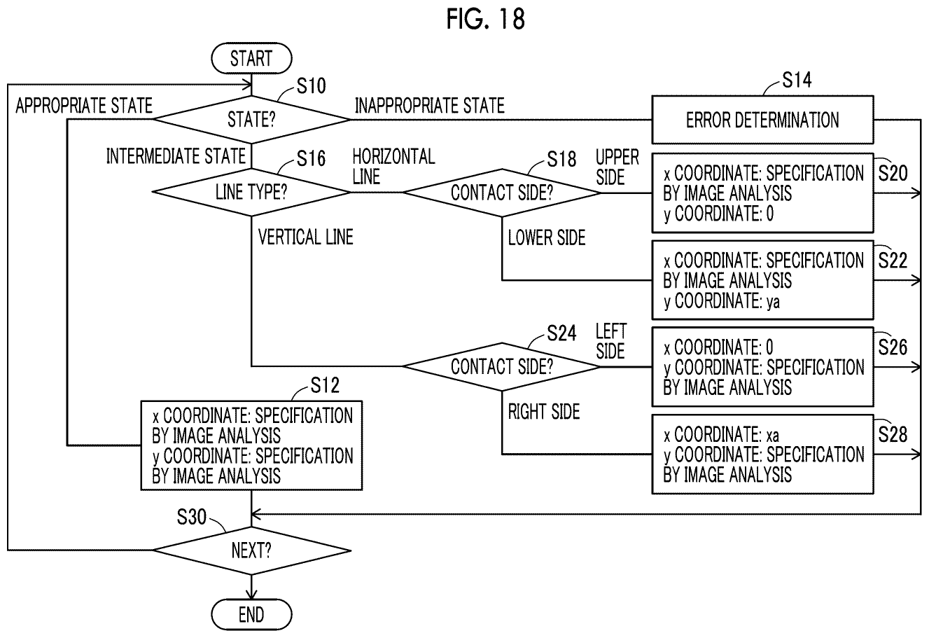

FIG. 18 is a flowchart showing a flow of processing in the image analyzer shown in FIG. 1. In S10, the partial image in the analysis region is analyzed, and the state of the partial image is determined. Specifically, the appropriate state, the intermediate state, or the inappropriate state is determined. In a case where the appropriate state is determined, in step S12, the actual position of the reference point is specified. That is, the x coordinate and the y coordinate of the reference point are calculated by analyzing the partial image. In a case where the inappropriate state is determined in step S10, an error is determined in step S14.

In a case where the intermediate state is determined in S10, in S16, a line type of the specific side (hereinafter, referred to as a contact side), which is in contact with the part (that is, the attention part) of the mark, is identified. In a case where the contact side is a vertical line, determination is made whether the contact side is an upper side or a lower side in S18. In a case where the determination is made that the contact side is the upper side in S18, the position of the contact point of the attention part with respect to the upper side is set as the temporary position in S20. Specifically, the x coordinate of the attention part is specified by analyzing the partial image. As the y coordinate of the attention part, 0 (zero), which is the y coordinate of the upper side, is specified.

In a case where the determination is made that the contact side is the lower side in S18, the position of the contact point of the attention part with respect to the lower side is set as the temporary position in S22. Specifically, the x coordinate of the attention part is specified by analyzing the partial image. As the y coordinate of the attention part, ya, which is the y coordinate of the lower side, is specified.

In a case where the contact side is a vertical line, determination is made whether the contact side is a left side or a right side in S24. In a case where the determination is made that the contact side is the left side in S24, the position of the contact point of the attention part with respect to the left side is set as the temporary position in S26. Specifically, as the x coordinate of the attention part, 0 (zero), which is the x coordinate of the left side, is specified. The y coordinate of the attention part is specified by analyzing the partial image. In a case where the determination is made that the contact side is the right side in S24, the position of the contact point of the attention part with respect to the right side is set as the temporary position in S28. Specifically, as the x coordinate of the attention part, xa, which is the x coordinate of the right side, is specified. The y coordinate of the attention part is specified by analyzing the partial image.

In S30, determination is made whether or not to analyze the next mark. In a case where the next mark is analyzed, each step after S10 is executed again.

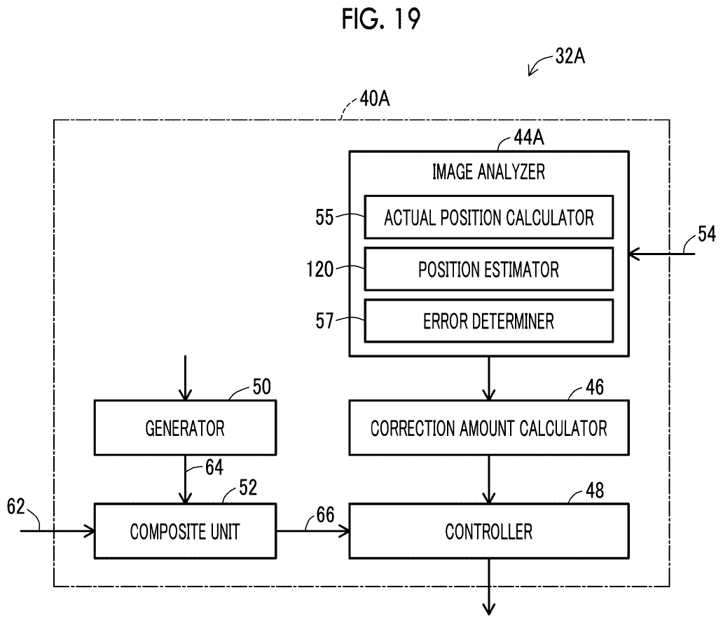

FIG. 19 shows a modification example. In FIG. 19, the same configurations as the configuration in FIG. 2 are denoted by the same reference numerals, and the description thereof will be omitted.

A control portion 32A includes a processor 40A. The processor 40A functions as an image analyzer 44A. The image analyzer 44A includes the actual position calculator 55, a position estimator 120, and the error determiner 57. As already described, the actual position calculator 55 calculates the actual position of the reference point in the appropriate state. As already described, the error determiner 57 determines an error in the inappropriate state.

The position estimator 120 estimates the position of the reference point in the intermediate state and defines the estimated position as the temporary position. In a case of estimating the position, an extrapolation method, which will be described below, may be used, or another method may be used.

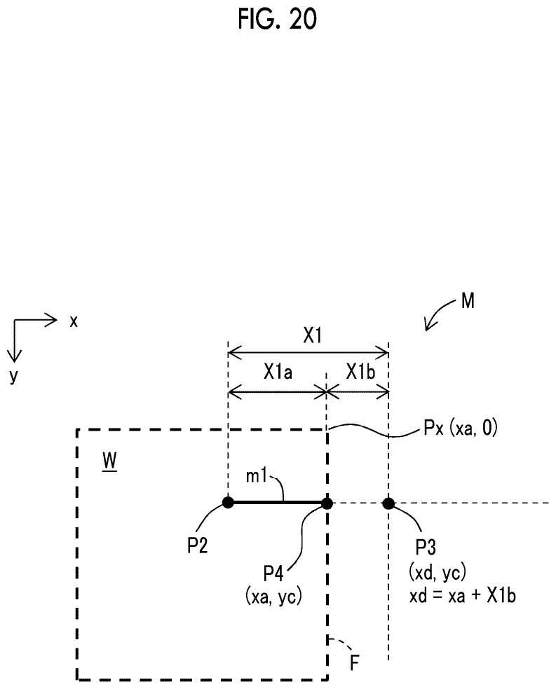

FIG. 20 shows a method of estimating the actual position. Only the part m1 of the mark M is included in the analysis region W, and the intermediate state occurs. By using the above-described method, the coordinates of the end point P2 and the coordinates of the contact point P4 may be specified. A length X1 of the horizontal line is known, and a distance X1a between the end point P2 and the contact point P4 may be easily calculated. A length X1b to be extrapolated is obtained by subtracting the distance X1a from X1. For example, the coordinates (xd, yc) of the reference point may be specified based on the coordinates (xa, yc) of the contact point P4 and the length X1b. The estimated coordinates are set as the temporary position P3. xd is obtained by adding X1b to xa. Even in a case where the part m1 is inclined, the position of the reference point can be estimated by the extrapolation method, and the position can be set as the temporary position.

The temporary position may be defined on an extension line of the part. For example, the x coordinate may be defined by xd=xa+k×X1b. Here, k is a weight and is a numerical value of less than 1. A modification example can also be considered in which the temporary position is defined inside the outer frame F. In a case where the positional deviation amount is desired to be suppressed, such a modification example may be adopted. In this case, the temporary position may be defined on the part m1.

In a case where the temporary position is defined on the outer frame, the temporary position may be made close to the actual position, and the reliability degree of the temporary position may be increased. For example, in a case where the partial image includes noise, an estimation error is likely to occur in estimating the actual position of the reference point. In contrast, according to the above exemplary embodiment, the temporary position is defined on the attention part that can be actually observed in a direction where the mark is shifted. Therefore, the possibility that the actual position is included in the analysis region is increased at the time when the next position correction is performed.

In the above-described exemplary embodiment, although the partial image in the analysis region is analyzed while executing a print job, for example, the partial image in the analysis region may be analyzed in test printing, and a correction amount of the image forming position may be calculated based on the analysis result. In the above-described exemplary embodiment, an analysis region having another shape may be adopted in place of the rectangle-shaped analysis region. In this case, the size condition is defined according to the form of the analysis region and the form of the mark.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An image forming system comprising:
an image scanning portion that scans an image formed on a paper; and
a processor that controls image forming based on a scanned image obtained through scanning of the image scanning portion,
wherein the processor is configured to:
   define, in an intermediate state in which a reference point of a mark for positional deviation detection is not included in an analysis region set with respect to the scanned image and a part of the mark is included in the analysis region, a temporary position in place of an actual position of the reference point based on the part of the mark; and
   correct an image forming position on the paper based on the temporary position.
      (((2)))

The image forming system according to (((1))), wherein the processor is configured to:
define the temporary position on an outer frame of the analysis region or outside the outer frame.
   (((3)))

The image forming system according to (((2))),
wherein the temporary position is defined on the outer frame, and
the processor is configured to:
   in a case where the mark crosses a specific horizontal side of the outer frame, define a vertical coordinate of the temporary position based on a vertical coordinate of the specific horizontal side and define a horizontal coordinate of the temporary position based on a horizontal coordinate of the part of the mark; and
   in a case where the mark crosses a specific vertical side of the outer frame, define the horizontal coordinate of the temporary position based on a horizontal coordinate of the specific vertical side and define the vertical coordinate of the temporary position based on a vertical coordinate of the part of the mark.
(((4)))

The image forming system according to (((3))), wherein the processor is configured to:
identify the specific horizontal side or the specific vertical side by specifying at least one of a contact portion between the outer frame and the part of the mark, an end portion of the part of the mark in the outer frame, or a gap between the outer frame and the part of the mark.
   (((5)))

The image forming system according to (((4))), wherein the processor is configured to:
generate a vertically integrated image and a horizontally integrated image by integrating partial images in the analysis region in a vertical direction and a horizontal direction; and
specify at least one of the contact portion, the end portion, or the gap by analyzing the vertically integrated image and the horizontally integrated image.
   (((6)))

The image forming system according to (((3))),
wherein the horizontal coordinate or the vertical coordinate of the part of the mark is a horizontal coordinate or a vertical coordinate of a representative point that represents the part of the mark.
   (((7)))

The image forming system according to (((6))),
wherein the part of the mark is a line segment, and
the representative point is a contact point between the part of the mark and the outer frame.
   (((8)))

The image forming system according to any one of (((1))) to (((7))),
wherein the mark includes a first vertical line that extends in a vertical direction from the reference point and a first horizontal line that extends in a horizontal direction from the reference point,
an outer frame of the analysis region has a first vertical size in the vertical direction and a first horizontal size in the horizontal direction,
the first vertical line has a second vertical size that is smaller than the first vertical size in the vertical direction, and
the first horizontal line has a second horizontal size that is smaller than the first horizontal size in the horizontal direction.
   (((9)))

The image forming system according to (((8))),
wherein the mark further includes a second vertical line that is a vertical line extending in the vertical direction from the reference point and that is connected to the first vertical line via the reference point and a second horizontal line that is a horizontal line extending in the horizontal direction from the reference point and that is connected to the first horizontal line via the reference point,
the second vertical line has the second vertical size in the vertical direction, and
the second horizontal line has the second horizontal size in the horizontal direction.
   (((10)))

The image forming system according to any one of (((1))) to (9)))
wherein an outer frame of the analysis region has a first vertical size in a vertical direction and has a first horizontal size in a horizontal direction,
the mark has a size twice a second vertical size in the vertical direction and has a size twice a second horizontal size in the horizontal direction,
the second vertical size is smaller than the first vertical size, and
the second horizontal size is also smaller than the first horizontal size.
   (((11)))

The image forming system according to any one of (((1))) to (((10))), wherein the processor is configured to:
estimate, in the intermediate state, a position of the reference point based on the part of the mark and define the estimated position as the temporary position.
   (((12)))

The image forming system according to any one of (((1))) to (((11))), wherein the processor is configured to:
define, in an appropriate state in which the reference point of the mark is included in the analysis region, the actual position of the reference point and correct the image forming position based on the actual position; and
determine an error in an inappropriate state in which the mark is not included in the analysis region.
   (((13)))

The image forming system according to any one of (((1))) to (((12))), wherein the processor is configured to:
define the actual position or the temporary position based on a first scanned image obtained by scanning a first image formed on a first paper; and
correct in real time a position where a second image is formed on a second paper based on the actual position or the temporary position.
   (((14)))

A non-transitory computer readable medium storing a program that is executed in an image forming system including an image scanning portion that scans an image formed on a paper and a processor that controls image forming based on a scanned image obtained through scanning of the image scanning portion, the non-transitory computer readable medium storing a program causing the processor to execute a process comprising:
defining, in an intermediate state in which a reference point of a mark for positional deviation detection is not included in an analysis region set with respect to the scanned image and a part of the mark is included in the analysis region, a temporary position in place of an actual position of the reference point based on the part of the mark; and
correcting an image forming position on the paper based on the temporary position.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image scanning portion that scans an image formed on a paper; and
a processor that controls image forming based on a scanned image obtained through scanning of the image scanning portion,
wherein the processor is configured to:
define, in an intermediate state in which a reference point of a mark for positional deviation detection is not included in an analysis region set with respect to the scanned image and a part of the mark is included in the analysis region, a temporary position in place of an actual position of the reference point based on the part of the mark; and
correct an image forming position on the paper based on the temporary position.

2. The image forming system according to claim 1, wherein the processor is configured to:
define the temporary position on an outer frame of the analysis region or outside the outer frame.

3. The image forming system according to claim 2,
wherein the temporary position is defined on the outer frame, and
the processor is configured to:
in a case where the mark crosses a specific horizontal side of the outer frame, define a vertical coordinate of the temporary position based on a vertical coordinate of the specific horizontal side and define a horizontal coordinate of the temporary position based on a horizontal coordinate of the part of the mark; and
in a case where the mark crosses a specific vertical side of the outer frame, define the horizontal coordinate of the temporary position based on a horizontal coordinate of the specific vertical side and define the vertical coordinate of the temporary position based on a vertical coordinate of the part of the mark.

4. The image forming system according to claim 3, wherein the processor is configured to:
identify the specific horizontal side or the specific vertical side by specifying at least one of a contact portion between the outer frame and the part of the mark, an end portion of the part of the mark in the outer frame, or a gap between the outer frame and the part of the mark.

5. The image forming system according to claim 4, wherein the processor is configured to:
generate a vertically integrated image and a horizontally integrated image by integrating partial images in the analysis region in a vertical direction and a horizontal direction; and
specify at least one of the contact portion, the end portion, or the gap by analyzing the vertically integrated image and the horizontally integrated image.

6. The image forming system according to claim 3,
wherein the horizontal coordinate or the vertical coordinate of the part of the mark is a horizontal coordinate or a vertical coordinate of a representative point that represents the part of the mark.

7. The image forming system according to claim 6,
wherein the part of the mark is a line segment, and
the representative point is a contact point between the part of the mark and the outer frame.

8. The image forming system according to claim 1,
wherein the mark includes a first vertical line that extends in a vertical direction from the reference point and a first horizontal line that extends in a horizontal direction from the reference point,
an outer frame of the analysis region has a first vertical size in the vertical direction and a first horizontal size in the horizontal direction,
the first vertical line has a second vertical size that is smaller than the first vertical size in the vertical direction, and
the first horizontal line has a second horizontal size that is smaller than the first horizontal size in the horizontal direction.

9. The image forming system according to claim 8,
wherein the mark further includes a second vertical line that is a vertical line extending in the vertical direction from the reference point and that is connected to the first vertical line via the reference point and a second horizontal line that is a horizontal line extending in the horizontal direction from the reference point and that is connected to the first horizontal line via the reference point,
the second vertical line has the second vertical size in the vertical direction, and
the second horizontal line has the second horizontal size in the horizontal direction.

10. The image forming system according to claim 1,
wherein an outer frame of the analysis region has a first vertical size in a vertical direction and has a first horizontal size in a horizontal direction,
the mark has a size twice a second vertical size in the vertical direction and has a size twice a second horizontal size in the horizontal direction,
the second vertical size is smaller than the first vertical size, and
the second horizontal size is also smaller than the first horizontal size.

11. The image forming system according to claim 1, wherein the processor is configured to:
estimate, in the intermediate state, a position of the reference point based on the part of the mark and define the estimated position as the temporary position.

12. The image forming system according to claim 1, wherein the processor is configured to:
define, in an appropriate state in which the reference point of the mark is included in the analysis region, the actual position of the reference point and correct the image forming position based on the actual position; and
determine an error in an inappropriate state in which the mark is not included in the analysis region.

13. The image forming system according to claim 1, wherein the processor is configured to:
define the actual position or the temporary position based on a first scanned image obtained by scanning a first image formed on a first paper; and
correct in real time a position where a second image is formed on a second paper based on the actual position or the temporary position.

14. A non-transitory computer readable medium storing a program that is executed in an image forming system including an image scanning portion that scans an image formed on a paper and a processor that controls image forming based on a scanned image obtained through scanning of the image scanning portion, the non-transitory computer readable medium storing a program causing the processor to execute a process comprising:
defining, in an intermediate state in which a reference point of a mark for positional deviation detection is not included in an analysis region set with respect to the scanned image and a part of the mark is included in the analysis region, a temporary position in place of an actual position of the reference point based on the part of the mark; and
correcting an image forming position on the paper based on the temporary position.

15. An image forming method comprising:
defining, in an intermediate state in which a reference point of a mark for positional deviation detection is not included in an analysis region set with respect to a scanned image and a part of the mark is included in the analysis region, a temporary position in place of an actual position of the reference point based on the part of the mark; and
correcting an image forming position on a paper based on the temporary position.
